(19) United States
(12) Patent Application Publication
(10) Pub. No.: US 2017/0167974 A1
(43) Pub. Date: Jun. 15, 2017

(54) INFORMATION OBTAINING APPARATUS, INFORMATION OBTAINING METHOD, AND RECORDING MEDIUM

(71) Applicant: CANON KABUSHIKI KAISHA, Tokyo (JP)

(72) Inventor: Takayuki Koizumi, Yokohama-shi (JP)

(21) Appl. No.: 15/039,364

(22) PCT Filed: Nov. 12, 2014
(86) PCT No.: PCT/JP2014/080567

§ 371 Date: May 25, 2016

(30) Foreign Application Priority Data
Nov. 28, 2013 (JP) 2013-245901
Oct. 21, 2014 (JP) 2014-214672

(51) Int. Cl. G01N 21/3586; G01N 21/95

(52) U.S. Cl. CPC G01N 21/3586; G01N 21/9508; G01N 2201/0697; G01N 2201/06113

(57) ABSTRACT

The present invention relates to an information obtaining apparatus that obtains information of a sample, the information obtaining apparatus including an irradiation unit configured to irradiate the sample with a terahertz wave, a detection unit configured to detect the terahertz wave reflected by the sample, a spectrum obtaining unit configured to obtain a spectrum from a temporal waveform obtained by using a detection result of the detection unit, an angle information obtaining unit configured to obtain information related to an incident angle of the terahertz wave from the irradiation unit with respect to the sample by using the spectrum, and a control unit configured to adjust the incident angle by referring to the information related to the incident angle.

### TECHNICAL FIELD

The present invention relates to an information obtaining apparatus that obtains information of a sample by using a terahertz wave, an information obtaining method, and a recording medium.

### BACKGROUND ART

A terahertz wave is an electromagnetic wave having at least a part of frequency bands in a range higher than or equal to 30 GHz and lower than or equal to 30 GHz. A terahertz time domain spectroscopy (THz-TDS: THz-Time Domain Spectroscopy) is proposed as a spectroscopy using the terahertz wave. This is a method of obtaining a temporal waveform of the terahertz wave by detecting the terahertz wave while a timing at which an ultrashort pulse reaches a detector is changed.

An apparatus or the like configured to obtain information of a sample and perform imaging by using the obtained information of the sample has been developed by putting the above-described Hz-TDS method into practical use. A reflection-type THz-TDS apparatus configured to detect a reflected wave from a surface or an internal interface of the sample is used as the imaging apparatus.

In a case where the information of the sample is obtained by using the reflection-type THz-TDS apparatus, a reflectivity is changed in accordance with an incident angle. For that reason, to obtain the information of the sample at a satisfactory accuracy, an adjustment is to be performed in a manner that an incident angle of the terahertz wave with respect to the sample is fixed when respective points of the sample are measured.

As a method of adjusting the incident angle of the terahertz wave in the reflection-type THz-TDS apparatus, PTL 1 describes a method of performing an adjustment such that a focal position of the terahertz wave is set on the sample surface and also the terahertz wave is incident from a normal direction of the sample surface. For that reason, the sample surface is scanned plural times while the sample or a terahertz wave irradiation unit is moved. At that time, the incident angle of the terahertz wave with respect to the sample surface is adjusted by moving the sample or the irradiation unit in a manner that an amplitude of the temporal waveform of the terahertz wave reflected by the sample surface becomes the largest and also its pulse width becomes the smallest.

In addition, PTL 2 discloses an adjustment method for a case where the incident angle of the terahertz wave with respect to the sample surface or the sample internal interface is changed. According to this method, a plurality of detection units configured to detect the terahertz wave are provided to calculate a spot position of the terahertz wave beam on the basis of a difference in detected currents in the detection units, and the detection units are moved so as to establish a specified detection state.

### CITATION LIST

### Patent Literature

PTL, 1 PCT Japanese Translation Patent Publication No. 2007-503582

PTL 2 Japanese Patent No. 5126705

### SUMMARY OF INVENTION

### Technical Problem

To obtain the information of the sample at a high accuracy, the adjustment of the incident angle of the terahertz wave with respect to the sample is to be performed at a high accuracy. Furthermore, to adjust the incident angle of the terahertz wave with respect to the sample at a high accuracy, the incident angle of the terahertz wave with respect to the sample is preferably obtained and adjusted by using a signal of the terahertz wave with which the sample is actually irradiated.

The adjustment method for the incident angle disclosed in PTL 1 does not cope with a case where a local maximum value of the amplitude and a local maximum value of the pulse width have variations derived from the measurement accuracy of the THz-TDS apparatus and also does not cope with changes of the amplitude and the pulse width caused by a temporal change in a characteristic of the radiated terahertz wave.

The method disclosed in PTL 2 can cope with a change of a propagation path of the terahertz wave caused by the change of the incident angle by performing a three-dimensional rotation or translational movement of an optical path of probe light or the detection unit for the terahertz wave. However, an optical path length of the terahertz wave from the sample to the detection unit may vary for each irradiation position of the terahertz wave in some cases because of the change of the incident angle, and the method may not cope with a change of a beam shape of the terahertz wave caused by an influence from the variation of the optical path length in some cases.

### Solution to Problem

An information obtaining apparatus according to an aspect of the present invention relates to an information obtaining apparatus that obtains information of a sample, the information obtaining apparatus including: an irradiation unit configured to irradiate the sample with a terahertz wave; a detection unit configured to detect the terahertz wave reflected by the sample; a spectrum obtaining unit configured to obtain a spectrum from a temporal waveform obtained by using a detection result of the detection unit; an angle information obtaining unit configured to obtain information related to an incident angle of the terahertz wave from the irradiation unit with respect to the sample by using the spectrum; and a control unit configured to adjust the incident angle by referring to the information related to the incident angle.

Further aspects of the present invention will become apparent from the following description of exemplary embodiments with reference to the attached drawings.

### BRIEF DESCRIPTION OF DRAWINGS

FIG. 1 is a schematic diagram for describing a configuration of an information obtaining apparatus according to a first embodiment.

FIG. 2A is an explanatory diagram for describing a situation of a reflection of a terahertz wave in a reference state.

FIG. 2B is an explanatory diagram for describing a situation of a reflection of the terahertz wave in a case where an incident angle is changed.

FIG. 2C is an explanatory diagram for describing a situation of a reflection of the terahertz wave in a case where a position in a height direction is changed.

FIG. 3 is an explanatory diagram for describing a configuration of a supporting unit according to the first embodiment.

FIG. 4A is a correlation diagram between a variation of the incident angle at a rotation axis X and an amplitude spectrum according to the first embodiment.

FIG. 4B is a correlation diagram between a variation of the incident angle at a rotation axis Y and the amplitude spectrum according to the first embodiment.

FIG. 4C is a correlation diagram between a variation in the height direction and the amplitude spectrum according to the first embodiment.

FIG. 5 is a flow chart of an adjustment method for the incident angle according to the first embodiment.

FIG. 6 is a flow chart for an adjustment method for the incident angle according to a second embodiment.

FIG. 7A is an explanatory diagram for describing a situation where a terahertz wave irradiation is performed by a THz-TDS apparatus in a related art.

FIG. 7B is an explanatory diagram for describing a situation where a terahertz wave irradiation is performed by a THz-TDS apparatus according to a third embodiment.

FIG. 8 illustrates reflectivity spectra of paraffin obtained in Example 1.

FIG. 9 illustrates refractive index spectra of a normal site and a tumor site of a rat brain slice obtained in Example 2.

### DESCRIPTION OF EMBODIMENTS

### First Embodiment

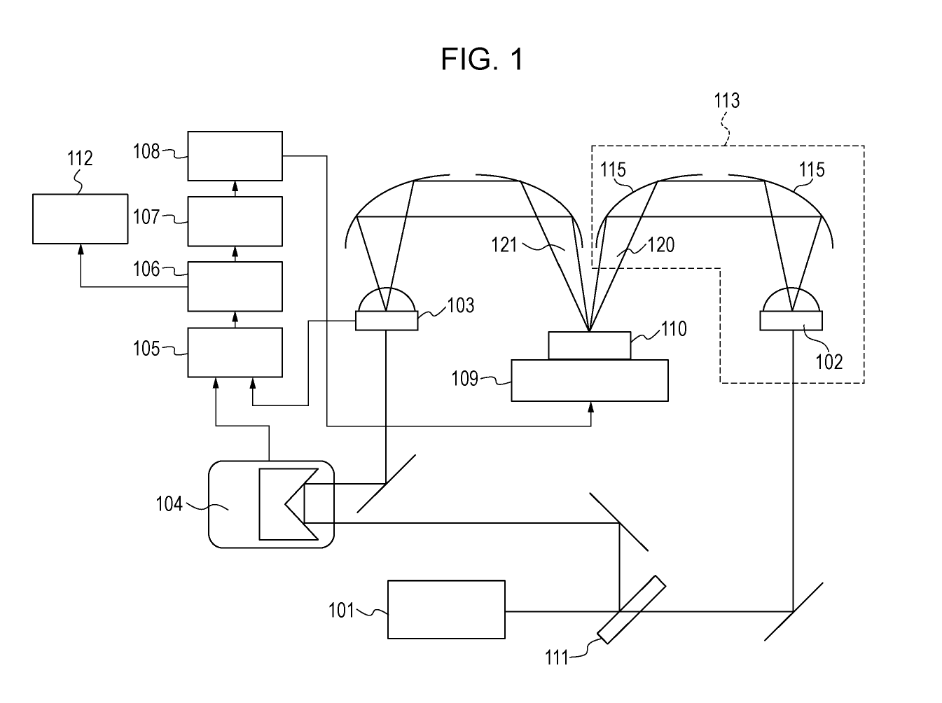

An information obtaining apparatus 100 according to the present embodiment. (hereinafter, referred to as “apparatus 100”) will be described with reference to FIG. 1. FIG. 1 is an explanatory diagram for describing a configuration of the apparatus 100. The apparatus 100 is a THz-TDS apparatus configured to measure a sample by using a terahertz wave and obtain information of the sample.

The apparatus 100 includes a measurement: mechanism in which the sample 110 is irradiated with a pulsed terahertz wave (incident wave) 120 to obtain a temporal waveform of a terahertz wave (reflected wave) 121 reflected by the sample 110. The apparatus 100 also includes a sample information obtaining unit 112 (hereinafter, referred to as “obtaining unit 112”) configured to obtain information of the sample from the obtained temporal waveform. The apparatus 100 further includes a spectrum obtaining unit 106 (hereinafter, referred to as “obtaining unit 107”), an angular information obtaining unit 107 (hereinafter, referred to as “obtaining unit 107”), a control unit 108, and a support unit 109 that supports the sample 110 and changes an incident angle of the incident wave 120 and a three-dimensional position of the sample 110.

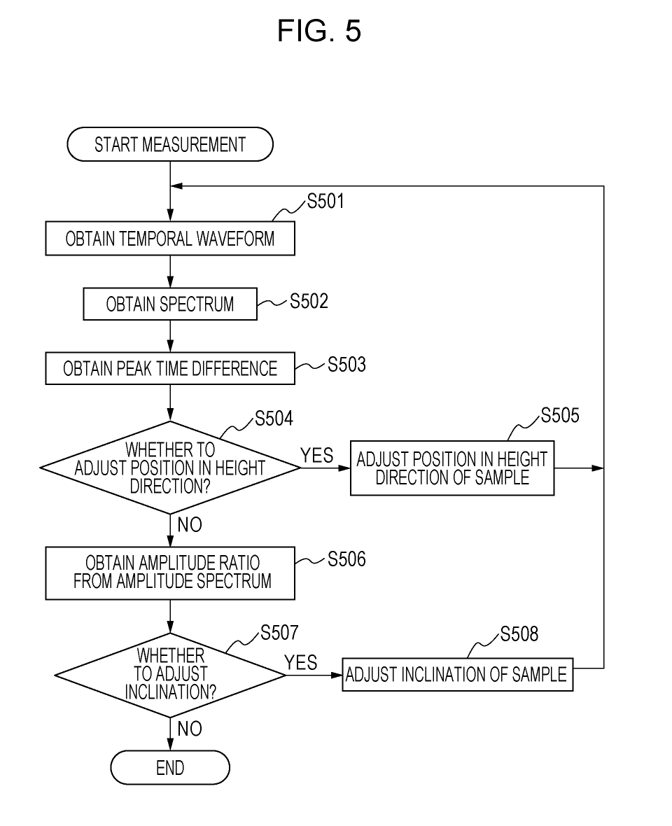

The apparatus 100 includes a computer provided with a CPU, a memory, a storage device, and the like, and this computer includes functions of be obtaining unit 106, the obtaining unit 107, the control unit 108, the obtaining unit 112, and the like. The computer also includes a storage unit that is not illustrated in the drawing and stores a detection result of a detection unit 103, a temporal waveform of the terahertz wave, a spectrum, and the like. The storage unit also stores a program corresponding to the respective steps of a flow chart in FIG. 5, and the CPU reads and executes the program, so that operations in the respective steps are carried out. The respective steps in FIG. 5 will be described below.

A measurement mechanism configured to measure a temporal waveform of the reflected wave 121 in a time domain includes a light source 101, an irradiation unit 113, the detection unit 103, a retardation optical unit 104, and a temporal waveform obtaining unit 105 (hereinafter, referred to as “obtaining unit 105”). The irradiation unit 113 is provided with a generation unit 102 and an optical system including a plurality of reflecting mirrors 115. It is noted that the obtaining unit 105 may be included in the computer in the apparatus 100.

The light source 101 is a section configured to output ultrashort pulse laser (hereinafter, simply referred to as “laser”) having, for example, an output of 200 mW and a pulse width of 30 fs. The generation unit 102 and the detection unit 103 are operated by carrier excitation by this laser. As illustrated in FIG. 1, the laser is branched into two optical paths by a beam splitter 111. One of the branched lasers is input to the detection unit 103 via the retardation optical unit 104. The laser passing through the other optical path is input to the generation unit 102.

The generation unit 102 generates a pulse wave of the terahertz wave corresponding to the incident wave 120. A technique for generating the pulse wave of the terahertz wave in the generation unit 102 includes a technique using a momentary current, a technique using an interband transition of the carrier, a technique using Cherenkov radiation, and the like.

The technique using the momentary current includes a technique for irradiating a surface of semiconductor, organic crystal, or nonlinear optical crystal with the laser to generate the terahertz wave in addition, a method of applying an electric field to a photoconductive element on which an antenna pattern is formed of metallic electrodes on a semiconductor thin film to irradiate the application unit with the laser, a PIN diode, and the like can also be employed. A technique using a semiconductor quantum well structure can be applied to the technique using the interband transition. According to the technique using electrooptic Cherenkov radiation, the laser is caused to propagate through the nonlinear optical crystal to generate the terahertz wave by a nonlinear optical effect. The terahertz wave radiated to the outside of the nonlinear optical crystal at an angle (Cherenkov angle) that satisfies a phase matching condition among the continuously generated terahertz waves is used as the incident wave 120.

The detection unit 103 is a section configured to detect the reflected wave 121. A detection method used in the detection unit 103 includes a technique for detecting a current corresponding to the electric field intensity by photoconduction and a technique for detecting the electric field by using the electric optical effect. Furthermore, the detection method also includes a technique for detecting a magnetic field by using a magneto-optic effect, a technique for guiding the reflected wave 121 and the laser into the nonlinear optical crystal to detect the laser affected by the reflected wave 121, and the like.

The photoconductive element can be applied to the technique for detecting the current by the photoconduction. A technique using an orthogonal polarizer and an electro-optic crystal can be applied to the technique for detecting the electric field by using the electric optical effect. A technique using an orthogonal polarizer and a magneto-optic crystal can be applied to the technique for detecting the magnetic field by using the magneto-optic effect. The terahertz wave 121 incident on the detection unit 103 focuses on the detection unit 103, so that the intensity per unit area can be increased, and the detection sensitivity can be enhanced.

The retardation optical unit 104 is a section where the detection unit 103 adjusts a position for sampling the signal of the reflected wave 121. Specifically, a timing of the laser input to the generation unit 102 is changed with respect to the laser input to the detection unit 103. According to the present embodiment, the retardation optical unit 104 is arranged on a propagation path of the laser input to the detection unit 103. However, the configuration is not limited to this. The retardation optical unit 104 may be arranged on a propagation path of the laser input to the generation unit 102, and the timing for the reflected wave 121 to be input to the detection unit 103 may also be changed.

An adjustment for a delay time includes a technique for directly adjusting an optical length and a technique for adjusting an effective optical length. The technique for directly adjusting the optical length includes a technique using a folding optical system and a movable part. The technique for adjusting the effective opticoptical length includes an arrangement of absorbent gas with which the phase can be retarded in the optical path of the laser and a method of changing the optical path by changing a refractive index. In addition, a method of delaying the generation of the incident wave 120 or the detection of the reflected wave 121 on the electric circuit side while a CR delay circuit or the like is incorporated, a method in a related art, and the like can be employed. FIG. 1 illustrates an example in which the folding optical system and the movable part are used.

The obtaining unit 105 is a section configured to obtain a construction of the temporal waveform of the terahertz wave 121. The adjustment amount by the retardation optical unit 104 and the output of the detection unit 103 are referred to, and the temporal waveform of the reflected wave is constructed. The configuration of the measurement mechanism has been described above.

Hereinafter, the other configurations will be described. The obtaining unit 106 obtains a spectrum from the temporal waveform obtained by the obtaining unit 105. The “spectrum” mentioned in the present specification refers to a spectrum of an optical characteristic where the horizontal axis is set as a frequency and includes an amplitude spectrum and a phase spectrum of the terahertz wave obtained by Fourier transform of the temporal waveform. If a reference is obtained in advance, it is possible to obtain the intensity spectrum, the reflectivity spectrum, the refractive index spectrum, the dielectric constant spectrum, the complex reflectivity spectrum, the complex refractive index spectrum, the complex dielectric constant spectrum, the complex electric conductivity spectrum, and the like.

The sample 110 is supported by the support unit 109, and the incident wave 120 generated in the generation unit 102 turns to parallel light by the plurality of reflecting mirrors 115 provided to the irradiation unit 113 to be then focused on the sample 110. The reflected wave 121 that has been reflected by the surface and the internal interface of the sample 110 turns to the parallel light again to be focused on the detection unit 103. The surface and the internal interface of the sample 110 are preferably within a range of a focal depth of the incident wave 120 and more preferably have a configuration where the imaging is made on the target sample internal interface. The change of these focal positions is performed by moving the support unit 109. In addition, a confocal mechanism with which the imaging is made at an arbitrary position in the height direction of the sample 110 may be provided.

The temporal waveform obtained by the obtaining unit. 105 and the spectrum obtained by the obtaining unit 106 are transferred to the obtaining unit 107 and the obtaining unit 112. The obtaining unit 107 uses the spectrum obtained by the obtaining unit 106 and obtains information related to the incident angle of the incident wave 120 with respect to the surface and the internal interface of the sample 110. In addition, according to the present embodiment, information related to the height direction of the sample 110 is also obtained, and those pieces of information are transferred to the control unit 108. For simplicity of the description, the information related to the incident angle and the information related to the height direction of the sample 110 are collectively referred to as sample surface information.

Art amplitude ratio of the amplitude spectrum is used as the information related to the incident angle, for example, but the information is not limited to this. For example, an amplitude ratio between an amplitude of a center frequency in the amplitude spectrum of the reflected wave 121 and an amplitude of a frequency higher than the center frequency can be used. The configuration is not limited to this, and a shape or a gradient of the amplitude spectrum, an integration value of the amplitude spectrum on a frequency axis, or the like may be used as the data and the information related to the incident angle. For example, an inclination or the like of a straight line that connects a point at a first frequency and a point at a second frequency on the amplitude spectrum to each other may be used. In addition, the spectrum used for obtaining the information related to the incident angle is not limited to the amplitude spectrum. For example, the inclination adjustment may be performed by analyzing the intensity spectrum, the reflectivity spectrum, the refractive index spectrum, the dielectric constant spectrum, or the like.

The “incident angle of the terahertz wave” mentioned in the present specification specifically refers to an incident angle θ of the incident wave 120 with respect to the sample surface or the sample internal interface and is an angle defined by a normal of the sample surface or the sample internal interface and a light axis of the incident wave 120 from the irradiation unit.

The control unit 108 controls the support unit 109 on the basis of the sample surface information obtained by the obtaining unit 107 and adjusts the incident angle of the incident wave 120 and the position in the height direction of the sample 110. For example, the adjustment is performed in a case where the incident angle defined when the reference used for obtaining the spectrum is measured and the incident angle defined when the sample 110 is measured are different from each other, a case where the incident angle and the position in the height direction of the sample are changed for each measurement point in the imaging on the surface of the sample 110, or the like.

The support unit 109 is a section configured to support the sample 110, and an inclination and a position thereof are controlled by the control unit 108. While the inclination and the position of the support unit 109 are changed, the inclination and the position of the sample 110 are changed, and the adjustment of the incident angle of the incident wave 120 and the position in the height direction of the sample 110 is performed.

The obtaining unit 112 is a section configured to obtain information of the sample 110. The obtaining unit 112 obtains the information of the sample 110 from the spectrum obtained by the obtaining unit 106. Herein, the “information of the sample 110” refers to various optical characteristics, shape, and the like on the surface of the sample 110 or the interface in the sample 110. The “shape of the sample 110” specifically includes a shape of an object in the sample 110, a shape of a region having a particular optical characteristic in the sample 110, and the like. The shape of the object in the sample 110 can be obtained by calculating depths up to the interface of the object in the sample 110 for the respective measurement points and connecting those depths to each other. In addition, the shape of the region having the particular optical characteristic in the sample 110 is a shape of a section having a particular optical characteristic which is found by obtaining the optical characteristics of the sample 110 for the respective measurement points.

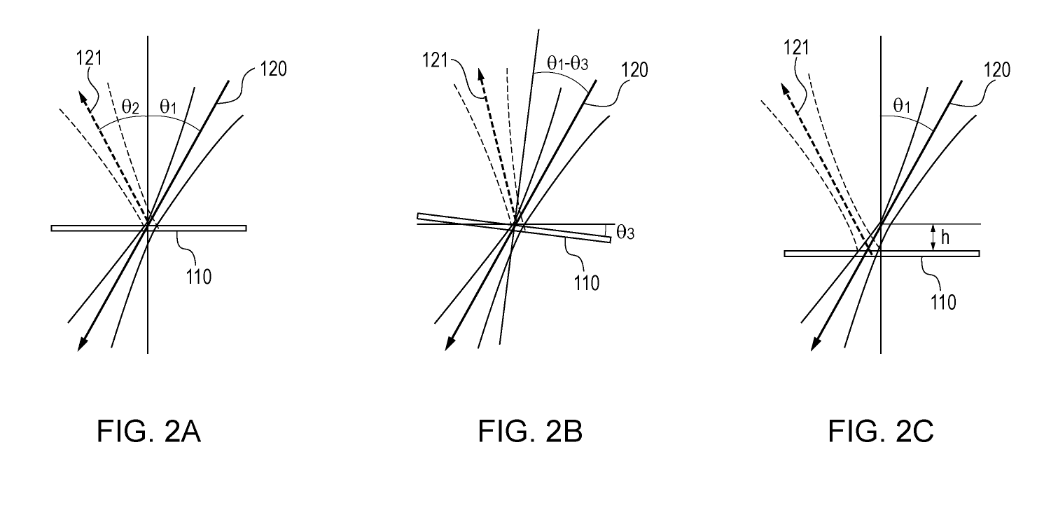

To specifically describe the present embodiment, an influence from the change of the incident angle of the incident wave 120 which affects the measurement will be simply described with reference to FIG. 2A and FIG. 2B. According to the present embodiment, since the unit configured to adjust the position in the height direction of the sample 110 is also provided, an influence from a fluctuation of the position in the height direction of the sample 110 which affects the measurement will also be described. It is noted that, to simplify the description herein, the incident wave 120 incident on the sample 110 and the reflected wave 121 that has been reflected by the sample 110 have no polarization and also are Gaussian beams.

FIG. 2A is a schematic diagram illustrating a state in which a relative position in the height direction between a converging position of the incident wave 120 and the sample 110 and the incident angle of the incident wave 120 are optimized in the apparatus 100. According to the present embodiment, the relative position in the height direction between the converging position of the incident wave 120 and the sample 110 is adjusted by changing the position in the height direction of the sample 110. Herein, the “converging position of the incident wave 120” refers to a position where a beam spot size of the incident wave 120 is minimized. An incident angle θ₁ is an angle defined by a line connecting the highest values of the intensity of the Gaussian beam of the incident wave 120 to each other and the normal of the surface of the sample 110. A reflection angle θ₂ is an angle defined by a line connecting the highest values of the intensity of the Gaussian beam of the reflected wave 121 that has been reflected by the sample 110 to each other and the normal of the surface of the sample 110. Herein, the angle defined by the normal of the surface of the sample 110 will be described, but an angle defined by a line connecting the highest values of the intensity of the Gaussian beam to each other and the internal interface of the sample 110 may be set as the incident angle θ₁ and the reflection angle θ₂.

The optical system including the plurality of reflecting mirrors 115 is set to be optimized in a case where the surface of the sample 110 is parallel to a horizontal plane and also a position in the height direction of a point at which the beam spot size of the incident wave 120 is the smallest and the intensity is the highest is matched with the surface of the sample 110. The above-described state in which the optical system is optimized will be hereinafter referred to as reference state.

FIG. 2B is a schematic diagram illustrating a propagation of the terahertz beam in a case where the surface of the sample 110 is inclined by θ₃ with respect to the reference state. At this time, the incident angle is set as (θ₁-θ₃). It is noted that the position in the height direction of the point at which the beam spot size of the incident wave 120 is the smallest and the intensity is the highest is matched with the surface of the sample 110.

In this case, the propagation paths of the incident wave 120 and the reflected wave 121 are changed by being affected by an influence from the inclination θ₃ of the surface of the sample 110. As a result, the beam spot of the incident wave 120 on the surface of the sample 110 is distorted, and also, a reflection angle of the reflected wave 121 is also changed. Furthermore, with regard to the incident wave 120, the optical path length is different from that in the reference state for each position in the beam spot on the surface of the sample 110. In addition, a fluctuation of the optical path length is caused in the beam spot, and an optical aberration occurs when the detection unit 103 detects the reflected wave 121.

It is noted that, herein, the case has been illustrated in which the inclination θ₃ is caused on the plane including the line connecting the highest values of the intensity of the incident wave 120 to each other and the line connecting the highest values of the intensity of the reflected wave 121 to each other, but a similar phenomenon occurs even in a case where the inclination is caused on a different rotation axis.

FIG. 2C is a schematic diagram illustrating a propagation of the terahertz beam in a case where the position in the height direction of the sample 110 is moved in a depth direction by h with respect to the reference state it is noted that the inclination of the surface of the sample 110 with respect to the incident wave 120, that is, the incident angle of the incident wave 120 is similar to that in the reference state illustrated in FIG. 2A.

In the case of the state illustrated in FIG. 2C, the beam spot size on the surface of the sample 110 of the incident wave 120 with which the surface of the sample 110 is irradiated is increased as compared with the reference state, and also, the propagation paths of the incident wave 120 and the reflected wave 121 are changed. As a result, when the imaging on the surface of the sample 110 is performed, a decrease of a horizontal resolution, a fluctuation of the optical path length for each position in the beam spot of the incident wave 120, or the like occurs, and the beam spot shape of the reflected wave 121 on the detection unit 103 is distorted.

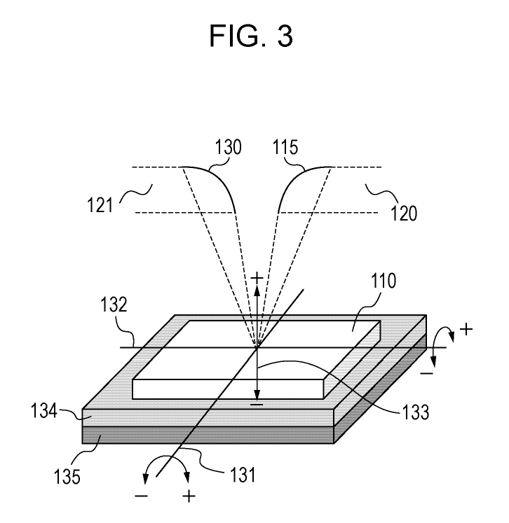

In this manner, the change of the incident angle of the incident wave 120 and the change of the position in the height direction of the sample 110 lead to the occurrence of the optical aberration of the detected reflected wave 121, and the accuracy for the measurement of the temporal waveform and the obtainment of the information of the sample 110 is affected. In view of the above, according to the present embodiment, the incident angle of the incident wave 120 and the position in the height direction of the sample 110 are adjusted in the apparatus 100. This method will be described in detail. First, the support unit 109 will be described with reference to FIG. 3. FIG. 3 illustrates mechanisms of the support unit 109 for adjusting the incident angle and the position in the height direction.

The support unit 109 includes a translational movement mechanism 134 (hereinafter, referred to as “mechanism 134”) and an inclination adjustment mechanism 135 (hereinafter, referred to as “mechanism 135”). The mechanism 134 can adjust the position of the sample 110 on a stage that supports the sample 110 by a movement of the mechanism 134. Specifically, the movement can be made in three directions including a direction parallel to a height axis 133 (height direction) and directions parallel to a rotation axis X 131 and a rotation axis Y 132 (plane directions), which also doubles a role of moving an irradiation position for the imaging in the plane directions of the sample 110.

The mechanism 135 is a mechanism that integrally rotates the mechanism 134 and the sample 110 while the rotation axis X 131 and the rotation axis Y 132 are set as the axes to adjust the inclination of the sample 110, that is, the incident angle. According to the present embodiment, the incident angle of the incident wave 120 is adjusted by using these two mechanisms, and the position in the height direction of the sample 110 is also adjusted.

In a case where the inclination of the sample 110 is changed, if the adjustment amount is high, the irradiation position of the incident wave 120 in the plane directions of the sample 110 or the position in the height direction may be changed in some cases. In addition, also in a case where the position in the height direction of the sample 110 is changed, the irradiation position of the incident wave 120 may be changed in some cases. That is, the irradiation position of the incident wave 120 with respect to the sample 110 may be shifted from a desired measurement point. In the above-described case, the adjustment is preferably performed such that the irradiation of the incident wave 120 is carried out at the desired measurement point by performing the translational movement with regard to the three axes again.

For that reason, to simplify the translational movement, after the inclination has been adjusted for each measurement point of the sample 110, the mechanism 135 is preferably installed under the mechanism 134 as illustrated in FIG. 3. In this case, by adopting the configuration in which the mechanism 135 is not moved in the plane directions even when the mechanism 134 is moved in the plane directions, it is possible to set the positional relationship between rotation centers of the three axes and the measurement point to be fixed. For that reason, the movement amounts in the XYZ directions corresponding to the inclination adjustment are substantially unchanged at any measurement point in the plane of the sample 110. In particular, in the case of the configuration in which the rotation centers of the two axes of the mechanism 135 are matched to the measurement point, the movement adjustment in the XYZ directions after the inclination has been changed may be avoided.

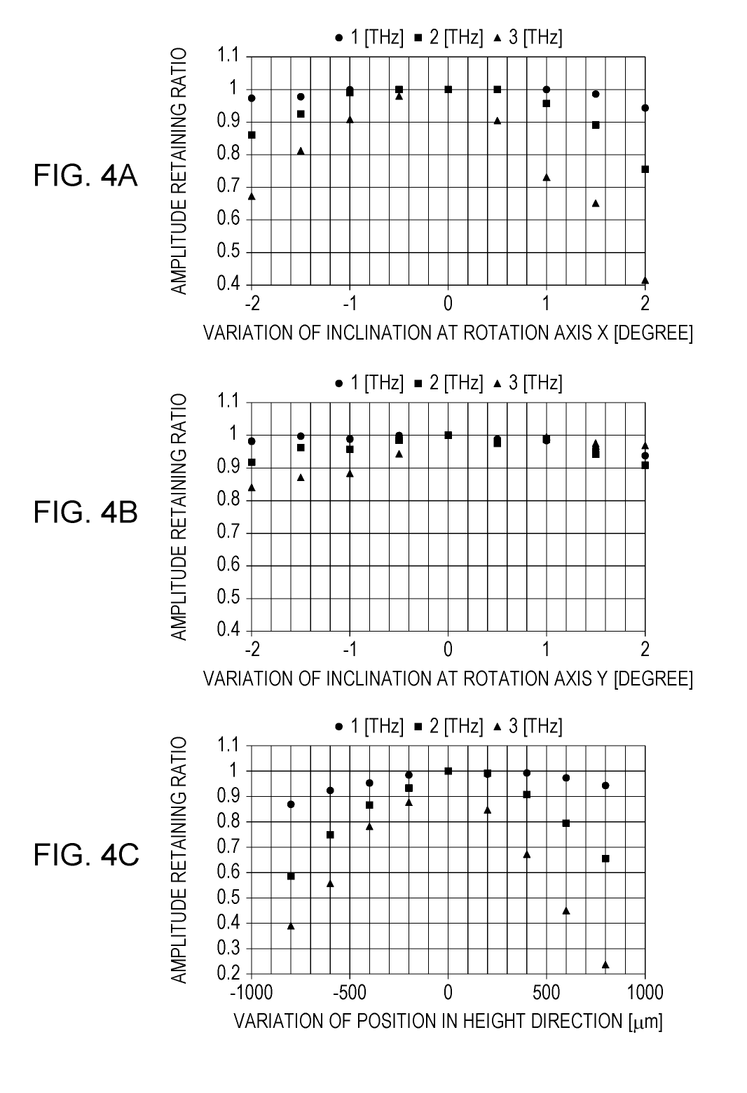

Subsequently, a method of obtaining the adjustment amount in a case where the incident angle of the incident wave 120 is adjusted will be described. FIG. 4A, FIG. 4B, and FIG. 4C illustrate values of an amplitude retaining ratio of the amplitude spectrum of the reflected wave 121 with respect to the respective frequencies when the incident angle of the incident wave 120 and the position in the height direction of the sample 110 are changed and represent correlations between the changes of the incident angle and the position in the height direction and the spectrum of the reflected wave 121. Herein, when the amplitude values at the respective frequencies obtained in the reference state are set as 1, the amplitude retaining ratio represents a ratio thereto.

First, a flat plate-like member for measuring the reference is arranged on the support unit 109 as the sample 110 to perform the measurement in the apparatus 100 as a prerequisite. At this time, the optical system is optimized such that the plate-like member is irradiated at the position where the reflection surface is horizontal and also the spot size of the terahertz wave is minimized as illustrated in FIG. 2A. It is noted that the apparatus used herein is not limited to the apparatus 100, and any THz-TDS apparatus may be used.

Dipole antenna-type photoconductive elements are used for both the generation unit 102 and the detection unit 103, and the sample 110 is irradiated with the generated incident wave 120 via the two parabolic reflecting mirrors 115. Thereafter, the reflected wave 121 that has been reflected by the sample 110 turns to parallel light by a parabolic mirror 130 and then converges onto the detection unit 103 by using a parabolic mirror that is not illustrated in the drawing. Accordingly, the reflected wave 121 is detected by the detection unit 103. The incident wave 120 and the reflected wave 121 are broad-band terahertz waves, and the center frequency is approximately 1 THz.

The amplitude spectrum of the reflected wave 121 is obtained by respectively independently changing the inclinations of the sample, that is, the incident angles of the incident wave 120 by using the mechanism 135 while the rotation axis X 131 and the rotation axis Y 132 are set as the axes from the above-described optimized state (reference state). In addition, the sample 110 is moved in the direction of the height axis 133 by using the mechanism 134 to investigate an influence on the amplitude spectrum of the reflected wave 121.

FIG. 4A is a correlations diagram between variations of the inclination when the sample 110 is inclined in both plus and minus directions while the rotation axis X 131 is set as the axis and amplitude values for the respective frequencies when the amplitude spectrum of the reflected wave 121 of the reference measured in the reference state is set as the reference. With regard to the amplitude spectrum at 1 THz, it may be understood that an attenuation of the amplitude with respect to the change of the incident angle is minor, but the attenuation of the amplitude with respect to the change of the incident angle becomes prominent as the frequency is increased. In addition, it may be understood that a tendency of the attenuation of the amplitude value differs depending on the inclination direction at the rotation axis X 131.

FIG. 4B is a correlation diagram between variations of the inclination when the sample 110 is inclined in both plus and minus directions while the rotation axis Y 132 perpendicular to the above-described rotation axis X 131 is set as the axis and amplitude values for the respective frequencies. Similarly as in the tendency at the rotation axis X 131, the attenuation of the amplitude with respect to the change of the incident angle is prominent as the frequency is increased, but overall, the attenuation of the amplitude value itself is minor as compared with the rotation axis X 131. In addition, it may be understood that a tendency of the attenuation of the amplitude value differs depending on the inclination direction at the rotation axis Y 132.

FIG. 4C is a correlation diagram between variations of the position in the height direction when the sample 110 is moved in both plus and minus directions of the height axis 133 and amplitude values for the respective frequencies when the amplitude spectrum of the reflected wave 121 of the reference measured in the reference state is set as the reference. Similarly as in the correlation between the variation of the incident angle and the attenuation of the amplitude value, the attenuation of the amplitude value is minor with respect to the change of the position in the height direction at the amplitude spectrum at 1 THz, but the attenuation of the amplitude value with respect to the change of the height becomes prominent as the frequency is increased. In addition, it may be understood that a tendency of the attenuation of the amplitude value differs depending on the direction of the height shift in the height axis 133.

It is conceivable that a reason why the terahertz wave having a higher frequency is more sensitive to the changes of the incident angle and the position in the height direction is that the beam spot size on the detection unit 103 is relatively small, and the focal depth is narrow because the terahertz wave has a shorter wavelength as the frequency is higher. The terahertz wave having the higher frequency has a smaller beam spot size on the detection unit 103 than the terahertz wave having a lower frequency. For that reason, the beam spot size is on par with or smaller than a detection region of the detection unit 103. Therefore, the influence from the distortion of the beam spot shape of the reflected wave 121 is more easily reflected. On the other hand, the terahertz wave having the lower frequency has the beam spot size sufficiently large with respect to the detection region of the detection unit 103. For that reason, the terahertz wave having the lower frequency is less likely to be reflected by the influence form the distortion of the shape of the reflected wave 121 or the aberration and is insensitive to the changes of the inclination and the height.

In addition, with regard to the incident angle, a reason why the difference of the attenuation tendency of the amplitude value exists depending on the difference of the rotation axis and the rotation direction originates from the relative relationship between the detection region of the detection unit 103 and the beam shape of the reaching reflected wave 121. In a case where the attenuation of the amplitude value is prominent, it is suggested that the amount of the components of the reflected wave 121 reaching out of the detection region of the detection unit 103 is high.

When the temporal waveform used for obtaining the amplitude spectrum is discussed, a result in which a peak value of the pulse of the temporal waveform is highest and a full-width at half-maximum is lowest is obtained in the reference state as illustrated in FIG. 2A. This is a result that does not contradict with the situation where the amplitude value of the reflected wave 121 attenuates along with the change of the incident angle or the position in the height direction. However, the peak value of the pulse and the full-width at half-maximum of the temporal waveform hardly change in a case where the inclination of the sample 110 is lower than or equal to 0.5° and is therefore minute. From this, it may be understood that it is difficult to adjust the minute change of the inclination or the height at a satisfactory accuracy when the peak value and the full-width at half-maximum of the temporal waveform are simply used.

According to the present embodiment, the temporal waveform is obtained from the detection result where the reflected wave 121 has been detected, and the amplitude spectrum is obtained by using the temporal waveform. Since the amplitude spectrum includes the information on the incident angle of the incident wave 120 as illustrated in FIG. 4A and FIG. 4B, the information related to the incident angle of the incident wave 120 can be obtained from the amplitude spectrum. Furthermore, it is possible to adjust the incident angle on the basis of the obtained information related to the incident angle. In addition, since the amplitude spectrum also includes the information related to the position in the height direction of the sample 110, not only the incident angle but also the position in the height direction can be adjusted. At this time, it is possible to adjust the incident angle and the position in the height direction at a higher accuracy by using the information of the amplitude values at the respective frequencies.

Herein, adjusting processes for the incident angle while the obtaining unit 107 obtains the information related to the incident angle of the incident wave 120 and changes the inclination of the sample 110 by referring to the information will be described with reference to FIG. 5. FIG. 5 is a flow chart illustrating the adjustment processes for the incident angle according to the present embodiment.

The sample 110 is set to be flat to such an extent that scattering does not occur with respect to the incident wave 120 (for example, a deviation from flatness is lower than or equal to 10 μm). The obtaining unit 107 previously stores data representing a relationship between the incident angle and the amplitude spectrum. According to the present embodiment, while the amplitude spectrum measured and obtained in the reference state is set as the reference, the data representing the correlations between the variations of the inclination of the surface of the sample 110 and the position in the height direction and the amplitude values for the respective frequencies as in FIGS. 4A to 4C are previously obtained, and those pieces of data are stored in the obtaining unit. 107.

First, as a preliminary stage for adjusting the incident angle of the incident wave 120 with respect to the sample 110, that is, the inclination of the surface of the sample 110, the position in the height direction of the surface of the sample 110 is adjusted. First, in step S501, the sample 110 is irradiated with the pulsed incident wave 120 including a broad-band frequency, and the reflected wave 121 that has been reflected by the sample 110 is detected by the detection unit 103. The obtaining unit 105 obtains the temporal waveform of the reflected wave 121 from the detection result of the detection unit 103. The obtained temporal waveform is transmitted to the obtaining unit 106, and the obtaining unit 106 obtains the amplitude spectrum (S502).

The obtained temporal waveform and amplitude spectrum are transferred to the obtaining unit 107. The obtaining unit 107 obtains a difference between a time at which the peak of the reflected wave 121 in the obtained temporal waveform is detected and a detection time of the peak of the reflected wave 121 measured in the reference state (hereinafter, referred to as peak time difference) (S503). Thereafter, the variation of the position in the height direction is obtained from the obtained peak time difference, and it is determined whether or not the position in the height direction is to be adjusted (S504). When it is determined that the position is to be adjusted, the flow progresses to step S505. When it is determined that the position is not to be adjusted, the flow progresses to step S506.

In step S505, the obtaining unit 107 obtains the movement amount for adjusting the position in the height direction from the information of the peak time difference, and the control unit. 108 issues a command for moving the support unit 109 in the height direction into a direction where the peak time difference disappears. In response to the command, the support unit 109 moves in the height direction to adjust the position of the sample 110. When the adjustment of the position in the height direction is performed, the flow shifts to step S501. The temporal waveform is obtained again to check if the adjustment is accurately performed. This flow is executed until the peak time difference disappears. Alternatively, a flow may also be adopted in which a threshold is provided with regard to the adjustment of the height by taking into account a required measurement accuracy and a band of the terahertz wave used for the measurement, and the adjustment is performed until the peak time difference becomes smaller than or equal to the threshold.

In step S504, when the obtaining unit 107 determines that the adjustment of the height is not to be performed, the obtaining unit 107 obtains the information related to the incident angle. Herein, the amplitude ratio between the amplitude of the center frequency in the amplitude spectrum of the reflected wave 121 and the amplitude of the frequency higher than the center frequency is obtained as the information related to the incident angle (S506). In step S507, the adjustment amount of the incident angle as to how much the sample 110 is inclined in which direction of which rotation axis is obtained by referring to the data stored in the obtaining unit 107 and the amplitude ratio obtained in step S505, and it is determined whether or not the adjustment of the inclination is to be performed.

Herein, in a case where the incident wave 120 from the generation unit 102 is stable and no temporal change exists in the characteristic of the amplitude spectrum, the amplitude value may be simply used instead of the amplitude ratio. In addition, herein, the inclination of the surface of the sample 110 to an extent that the amplitude value at the center frequency of the reflected wave 121 does nit change is supposed. However, in the case of the large inclination change to an extent that the amplitude value at the center frequency also changes, the amplitude ratio may be calculated while a low frequency region lower than or equal to the center frequency is set as the reference. A frequency higher than the center frequency is preferably set on a higher frequency side within a range where the measurement accuracy is guaranteed. Furthermore, plural pieces of information of the amplitude ratio may also be prepared instead of one piece of information.

The amplitude ratio has the correlation between the inclination amount of the surface of the sample 110, the rotation axis of the inclination, and the rotation direction in accordance with the set two frequencies. Therefore, how much the amplitude ratio of the reflected wave 121 is shifted from the amplitude ratio of the reflected wave 121 measured in the reference state is obtained by referring to the data, and the adjustment amount of the inclination and the rotation axis of the inclination can be obtained.

In step S507, when it is determined that the adjustment of the inclination is to be performed, the control unit 108 rotates the support unit 109 in the direction where the inclination disappears and adjusts the incident angle on the basis of the adjustment amount obtained by the obtaining unit 107 (S508). It is noted that a flow may also be adopted in which a threshold is also provided with regard to the adjustment of the incident angle by taking into account the required measurement accuracy and the band of the incident wave 120 used for the measurement, and the adjustment is performed until the incident angle is set within a certain range from the incident angle in the reference state.

As described above, in a case where the inclination of the sample 110 is adjusted, if the adjustment amount is high, the irradiation position of the incident wave 120 in the plane directions of the sample 110 or the height may be changed in some cases. In the above-described case, the position of the sample 110 in the height direction and the plane directions is preferably adjusted again. According to the present embodiment, the mechanism 134 and the mechanism 135 as in FIG. 3 are provided, and the configuration where the rotation centers of the two axes of the mechanism 135 are matched with the measurement point is adopted, so that the above-described adjustment may be avoided.

With regard to the change of the position in the height direction of the sample 110, after the incident angle is adjusted in step S508, the flow shifts to step S501, and the temporal waveform is preferably obtained again to perform the checking. When it is determined that the adjustment of the position of the sample 110 and the incident angle may be avoided, the adjustment is ended.

It is noted that, in a case where the inclination direction of the sample 110 is matched with none of the two rotation axes in the adjustment of the incident angle, both the two rotation axes are to be adjusted. To prepare for the above-described case, the data representing the relationship between the incident angle and the amplitude spectrum as in FIG. 4A and FIG. 4B is processed, and data that can be used in a case where both the two axes are inclined is preferably prepared in advance. A case where both the two axes are inclined also has a tendency multiplied by the amplitude retaining ratio of the amplitude value with respect to the respective axes corresponding to the inclinations from the reference position, and therefore, the adjustment can be performed by obtaining the rotation direction and the inclination amount with respect to the two rotation axes.

In a case where the direction for rotating the sample 110 is not found in the adjustment of the incident angle of the terahertz wave, the following configuration is adopted. That is, the sample 110 is rotated in one of the plus direction and the minus direction on the basis of the obtained adjustment amount. Thereafter, the temporal waveform is measured again to obtain the amplitude spectrum, and the information related to the incident angle is obtained if the incident angle is farther away from the incident angle in the reference state in the obtained information related to the incident angle, the sample 110 is rotated in the direction opposite to the previous rotation direction.

As another method of adjusting the incident angle even in a case where the inclination direction is not found since the amplitude retaining ratios have substantially equal values in one rotation axis, it is also possible to employ a method of obtaining the amplitude ratios at two or more frequencies as the information related to the incident angle.

Specifically, data pieces of at least two or more frequencies are prepared with regard to the relationship between the amplitude retaining ratios at the respective frequencies and the incident angle, and the determination is performed on the basis of combinations of those amplitude retaining ratios. Accordingly, it becomes easier to discriminate the rotation direction of the inclination. The number of data pieces of the amplitude retaining ratios for the respective frequencies is preferably higher, and the plurality of data pieces are more preferably prepared uniformly across the entire frequency band of the incident wave 120 used for the measurement.

In a case where the data representing the relationship between the inclination and the position in the height direction of the sample 110 and the spectrum is not obtained, if the sample 110 is flat, the adjustment of the inclination can also be performed by using data obtained by measuring another object. That is, the measurement object surface, which is used for obtaining the data representing the correlation between the inclination and the position in the height direction and the spectrum, and the surface of the sample 110 are arranged on the support unit 109 so as to be in the same plane, and the adjustment of the inclination and the position in the height direction is performed on the measurement object surface. Since the measurement object and the sample 110 are both flat, and also the surfaces of those are in the same plane, if the adjustment is performed with respect to the measurement object surface, it is also possible to adjust the inclination and the position in the height direction of the sample 110.

When the imaging in the plane directions is performed with respect to the sample 110, if the adjustment of the incident angle and the position in the height direction of the sample 110 is performed for each measurement point, it is possible to perform the measurement at a high measurement accuracy. However, to reduce a measurement time, a configuration where the adjustment is not performed for each measurement point may also be adopted. For example, if the sample 110 is flat, a sufficient adjustment can be performed by only adjusting the position in the height direction and the incident angle at an end part of the region where the imaging is performed.

In addition, to reduce the time used for the adjustment of the incident angle and the position in the height direction, a mode for performing rapid scan in which the retardation optical unit 104 is moved at a high speed to obtain the temporal waveforms without performing the integration processing of the temporal waveforms is provided, and the mode is switched to this.

According to the above-described configuration, it is possible to adjust the incident angle of the terahertz wave with respect to the sample at a satisfactory accuracy by using the detection result of the reflected wave 121. The incident angle of the incident wave 120 with respect to the sample 110 can be adjusted at a satisfactory accuracy. In addition, the position in the height direction of the sample 110 can be adjusted as well. Moreover, the spectrum is obtained by using the terahertz wave similar to the case where the information of the sample 110 is obtained, and the information related to the incident angle can be obtained from the obtained spectrum. For that reason, the influence from the inclination is reduced also in the obtainment of the information of the sample 110, and it is possible to perform the higher accuracy measurement as compared with the case where the spectrum is not used.

### Second Embodiment

An information obtaining apparatus according to a second embodiment will be described. Descriptions of parts common to the descriptions so far will be omitted. A configuration of the information obtaining apparatus according to the present embodiment is different from the apparatus 100 according to the first embodiment in that a configuration for adjusting the inclination of the sample 110 is provided, but the other configurations are similar to the apparatus 100.

According to the first embodiment, with regard to the sample 110, the data representing the correlation between the incident angle and the position in the height direction and the amplitude spectrum as in FIG. 4A, FIG. 4B, and FIG. 4C is previously obtained, and the adjustment of the incident angle is performed by referring to the data. In a case where the information of the sample 110 whose data has not been obtained is obtained, if the sample 110 is flat, the adjustment of the incident angle is performed while it is assumed that the measurement object surface whose data has been already obtained and the surface of the sample 110 are in the same plane.

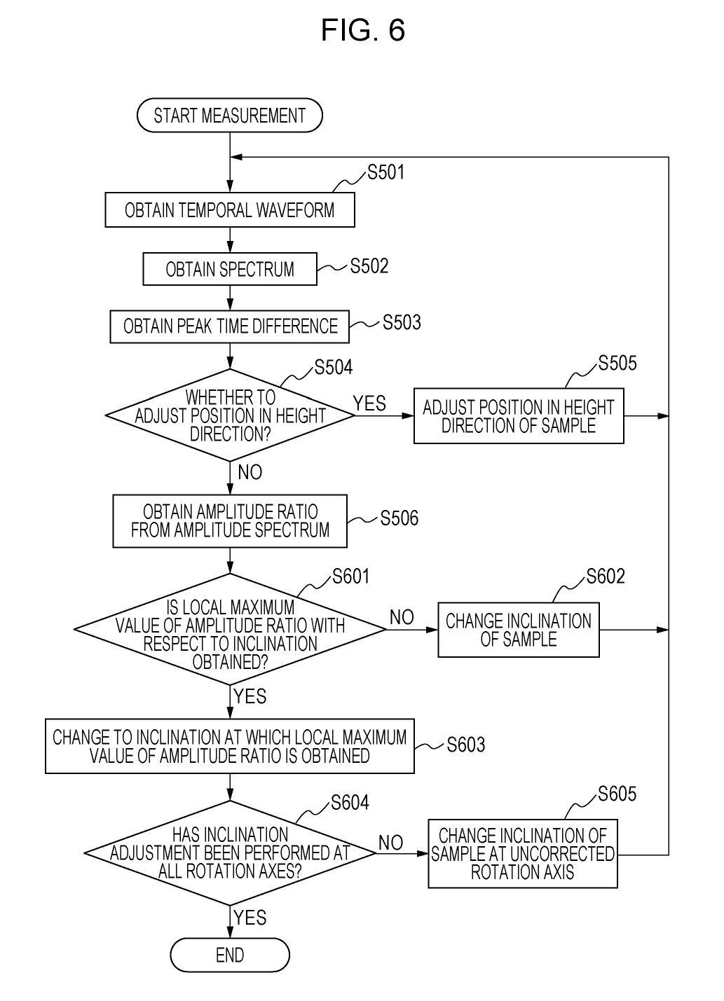

According to the present embodiment, a method of adjusting the inclination of the sample 110 even in a case where the data is not previously obtained, a case where the terahertz wave has a possibility of being scattered on the surface of the sample 110, or the like, will be described by referring to FIG. 6. FIG. 6 is a flow chart illustrating the adjustment method for the incident angle according to the present embodiment. The storage unit (not illustrated) of the apparatus 100 stores a program corresponding to the respective steps in the flow chart of FIG. 6, and the CPU reads and executes the program to perform respective processings.

First, similarly as in the first embodiment, in steps S501 to S505, the position in the height direction of the surface of the sample 110 is adjusted. In step 3504, when the obtaining unit 107 determines that the adjustment of the position in the height direction is not to be performed, the flow progresses to step S506, and the obtaining unit 107 obtains at least one ratio between the amplitude value of the center frequency in the amplitude spectrum of the reflected wave 121 and the amplitude value of the frequency higher than the center frequency. The processes so far are similar to those according to the first embodiment, and detailed descriptions thereof will be omitted.

Next, it is determined whether or not the amplitude ratio obtained in step S506 is a local maximum value (S601). In a case where the amplitude ratio is not the local maximum value, the flow shifts to step S602, and one of the rotation axes of the support unit 109 is used to change the inclination of the sample 110. Then, the flow shifts again to step S501, and the temporal waveform is obtained. Thereafter, the operations in steps S501 to 3505 and step S601 are repeatedly performed while the inclination of the sample of a certain rotation axis is changed. It is possible to obtain the inclination at which the amplitude ratio takes the local maximum value from the correlation between the amplitude ratio at this time and the inclination.

At this time, for example, first, the inclination at which the local maximum value is roughly obtained by changing the inclination at a pitch of approximately 1° in a width of approximately ±5°, and thereafter, the amplitude ratio in the vicinity of the local maximum is preferably obtained in detail at a pitch of approximately 0.1°. When the local maximum value of the amplitude ratio is obtained in step S601, the control unit 108 issues an instruction to adjust the support unit. 109 to have the inclination at which the local maximum value is obtained (S603). When the incination is adjusted such that the amplitude ratio becomes the local maximum value in a certain rotation axis, in step S604, it is checked whether or not the inclination is adjusted with regard to all the rotation axes. In a case where the adjustment of the inclination is not performed with regard to all the rotation axes, the flow shifts to step S605, and the similar operation is performed with regard to the other rotation axis.

It is noted that the flow shifts to step S501 after the operations in step S602 and step S605, but the processes in steps S502 to S504 may be omitted in the case of the configuration in which the position in the height direction is not changed even when the inclination of the sample 110 is changed.

To simplify the adjustment of the inclination, two axes are preferably prepared in directions orthogonal to each other as the rotation axes of the support unit 109 for changing the inclination of the sample 110. It is noted that this technique can be applied to the sample 110 having a random surface roughness approximately at a wavelength of the incident wave 120. In a case where the surface of the sample 110 is rough, the attenuation amount of the amplitude ratio with respect to the inclination is smaller than the sample 110 having the flat surface, but the local maximum value can be obtained when the influence from the inclination of the sample 110 is removed.

When the imaging in the plane directions is performed with respect to the sample 110, if the adjustment of the incident angle of the sample 110 and the position in the height direction is performed for each measurement point, it is possible to perform the high accuracy measurement. However, to reduce the measurement time, the temporal waveform may be obtained in simplified manner. In a case where the temporal waveforms is obtained in the simplified manner, the rapid scan is performed in the measurement region before the adjustment of the inclination and the position in the height direction of the sample 110. Accordingly, a three-dimensional shape of the sample 110 in the measurement region can be obtained from the peak position in the time axis of the temporal waveform. The three-dimensional shape of the sample 110 is saved as data the obtaining unit 107. Next, such a procedure may be adopted that the inclination and the position in the height direction of the sample 110 at a certain measurement point are adjusted, and the adjustment amount of the inclination and the movement amount of the position in the height direction at the other measurement point are estimated by referring to the above-described data of the three-dimensional shape.

According to the above-described configuration, even in a case where the data representing the correlation between the incident angle and the position in the height direction and the amplitude spectrum is not provided, a case where the surface of the sample 110 is not flat and has a possibly of scattering, or the like, the incident angle of the terahertz wave with respect to the sample 110 can be adjusted more accurately than the related art.

### Third Embodiment

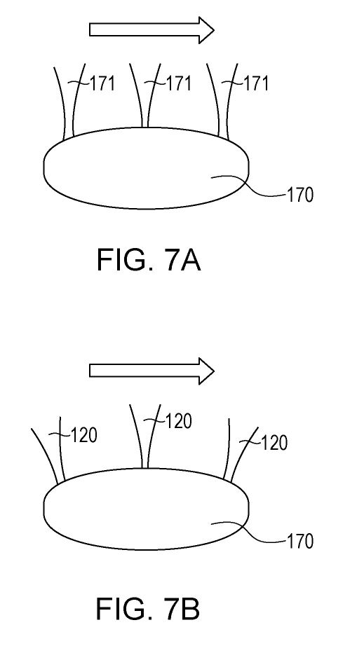

According to a third embodiment, a method of adjusting the incident angle of the incident wave 120 and the position in the height direction of the sample 110 even in a case where the information of the sample 110 having a curvature without the flat surface is obtained will be described. Descriptions of parts common to the descriptions so far will be omitted. According to the present embodiment, an example will be illustrated in which a cross-sectional image of a tablet 170 is obtained by using the tablet 170 as the sample 110 having a curvature. FIG. 7A illustrates a situation where the tablet 170 is irradiated with the incident wave 120 by using the THz-TDS apparatus in the related art which does not include the unit configured to adjust the incident angle, and FIG. 7B illustrates a situation where the tablet 170 is irradiated with the incident wave 120 by using the apparatus 100.

In a case where the adjustment of the incident angle is not performed, as illustrated in FIG. 7A, even when the surface has a curvature, the direction of the terahertz wave 171 with which the tablet 170 is irradiated is fixed. For that reason, since the inclination at an end part of the surface of the tablet 170 is larger than a part in the vicinity of the center, even when the optical system is optimized in the vicinity of the center of the tablet 170, the incident angle at the end part is shifted from the reference state. For that reason, it is difficult to obtain the information of the tablet 170 at a high accuracy.

On the other hand, as illustrated in FIG. 7B, when the incident angle and the position in the height direction are adjusted for each measurement point of the tablet. 170 by using the apparatus 100, it is possible to obtain the information of the tablet 170 more accurately than the THz-TDS apparatus in the related art. In addition, both the shape of the tablet 170 and the information of the sample 110 can be obtained at a satisfactory accuracy by storing the obtained sample surface information, the adjustment amount of the incident angle for each measurement point, the movement amount of the position in the height direction, and the like.

In a case where the apparatus 100 is used for a quality inspection of the tablet 170, a large number of the tablets 170 are to be inspected at a high speed. For that reason, for example, vapor deposition or coating of a film having a high reflectivity with respect to the terahertz wave is applied onto the surface of the tablet 170. Then, the incident wave 120 is irradiated with the tablet 170 that has the surface covered with the film having the high reflectivity to perform the measurement. A combination of the shape of the tablet 170, the adjustment amount of the inclination for each measurement point, and the movement amount of the position in the height direction or any one of those may be stored as data on the basis of the sample surface information obtained by the obtaining unit 107. Accordingly, the adjustment of the incident angle and the position in the height direction at the time of the quality inspection is facilitated, and the throughput can be improved.

According to the above-described configuration, also with regard to the sample 110 having a curvature where the surface is not flat, the incident angle of the terahertz wave with respect to the sample 110 can be adjusted at a satisfactory accuracy by using a detection result of the terahertz wave reflected by the sample 110.

### EXAMPLE 1

The adjustment of the incident angle of the incident wave 120 by using the apparatus 100 and the obtainment of the information of the sample 110 will be described in more detail. It is noted that descriptions of parts common to the descriptions so far will be omitted.

A paraffin block that is typical for an embedding substance of a pathologic tissue is used as the sample 110, and its surface is cut by a microtome to form a smooth surface before evaluation. An arithmetic mean roughness Ra of the surface is lower than or equal to 1 μm.

According to the present example, a reflectivity spectrum of the paraffin block surface is obtained as information of the sample 110. The reflectivity spectrum is obtained by taking a ratio between an intensity spectrum of a reflected wave that has been reflected by an aluminum plate on which mirror polishing has been applied, which is used as a reference, and an intensity spectrum of a reflected wave that has been reflected by the paraffin surface, which is used as the sample 110.

Each of the reference and the sample 110 is arranged on the support unit 109, and the inclination and the position in the height direction are respectively adjusted. Then, the measurement of each of the reference and the sample 110 is performed in conformity to the adjust method in a case where the data of the sample 110 according to the first embodiment is previously obtained. Data including information of the amplitude ratios for the respective frequencies with respect to the minute inclination that is smaller than or equal to 0.5° is stored in the obtaining unit 107 in addition to the data representing the relationship between the incident angle and the amplitude spectrum illustrated in FIG. 4A and FIG. 4B and used for the adjustment of the inclination.

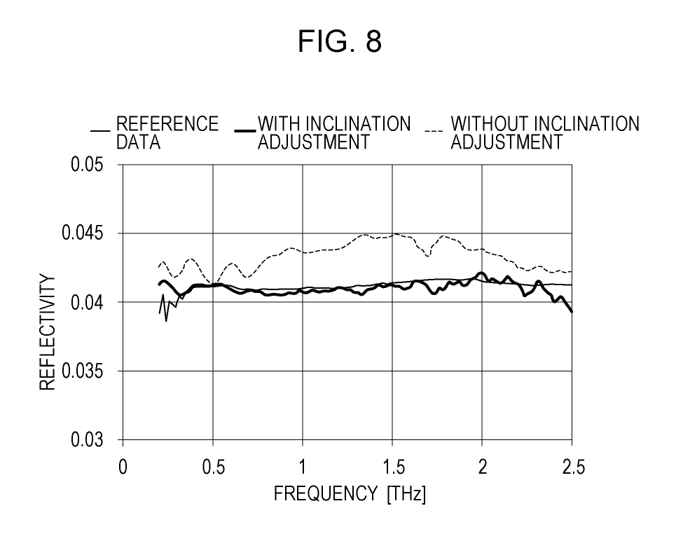

FIG. 8 illustrates a reflectivity spectrum of the thus obtained paraffin. For comparison, FIG. 8 also illustrates a reflectivity spectrum obtained from the temporal waveform that has been measured without adjusting the inclination of the reference and the inclination of the sample 110. These reflectivity spectra are measured by using the same paraffin under the same measurement conditions except for the adjustment of the inclination and the same measurement environment, and the position in the height direction of the sample 110 is adjusted before the measurement for both the reflectivity spectra. In addition to these reflectivity spectra, FIG. 8 further illustrates a reflectivity spectrum estimated from the incident angle of the terahertz wave at the time of the measurement in the present example by using data of a refractive index spectrum of the paraffin measured at a high accuracy by using another measurement unit as reference data.

From FIG. 8, it may be understood that the measurement values closer to the reference data can be obtained at all the frequencies when the adjustment of the incident angle of the sample 110 is performed.

In a case where the adjustment of the incident angle of the incident wave 120 is not performed, a tendency of the higher reflectivity than the reference data is obtained. It is conceivable that this is because the amplitude attenuates since the aluminum plate at the time of the reference measurement is different from the incident angle in the reference state and is inclined with respect to the horizontal plane. The inclination of the aluminum plate for the reference measurement and the surface of the paraffin block as the sample 110 in a case where the adjustment of the incident angle is not performed is within a range of approximately 0.5° when the horizontal plane is set as the reference. In contrast, the inclination of the aluminum plate for the reference measurement and the surface of the paraffin block as the sample 110 in a case where the adjustment of the incident angle is performed is within a range lower than or equal to 0.01°.

In this manner, according to the configuration of the present example, the incident angle can be adjusted at a satisfactory accuracy by using the detection result of the terahertz wave that has been reflected by the sample 110. In addition, the measurement can be performed in a state in which the optical system is optimized or in a state close to the optimized state by adjusting the incident angle of the incident wave 120 with respect to the sample 110. For that reason, the measurement accuracy of the temporal waveform of the terahertz wave and eventually the obtainment, accuracy of the information of the sample 110 are improved.

### EXAMPLE 2

The present example illustrates an example of a case where a living matter slice is set as the sample 110, and information of the sample 110 is obtained by using the apparatus 100. The living matter slice is used as the sample 110, and a refractive index spectrum is obtained as the information of the sample 110. The living matter slice as the sample 110 is irradiated with the incident wave 120 via the z-cut crystal plate in a state in which the living matter slice is adhered onto a crystal plate (hereinafter, “z-cut crystal plate”) that has 1 mm in thickness, 25 mm in height, and 70 mm in width and is cut by a Z-plane where its complex refractive index is already found. It is noted that descriptions of parts common to the descriptions so far will be omitted.

A brain slice obtained by slicing a brain tissue of a rat having a malignant tumor artificially created in the brain is used as the sample 110. The sample 110 is irradiated with the incident wave 120 from a side on which the sample 110 of the z-cut crystal is not adhered in a state in which the sample 110 is adhered onto the z-cut crystal plate. The obtaining unit 105 obtains the temporal waveform of the reflected wave 121 including the reflected wave that has been reflected by the interface between the air and the z-cut crystal plate and the reflected wave that has been reflected by the interface between the z-cut crystal plate and the sample 110 by using the detection result of the detection unit 103. A refractive index spectrum of the brain slice as the sample 110 is obtained from the obtained temporal waveform.

It is noted that the data representing the relationship between the inclination of the z-cut crystal plate in the reference state and the amplitude spectrum is previously obtained. Before the measurement of the temporal waveform of the reflected wave 121 for obtaining the refractive index spectrum of the brain slice, the adjustment of the inclination of the z-cut crystal plate is performed by using the amplitude spectrum of the reflected wave from the interface between the air and the z-cut crystal plate. A thickness tolerance of the z-cut crystal plate is lower than or equal to ±10 μm in the plane of the z-cut crystal plate, and if the adjustment of the inclination of the interface between the air and the z-cut crystal plate is performed, it is regarded that the inclination of the interface between the z-cut crystal plate and the sample 110 as also adjusted at the same time.

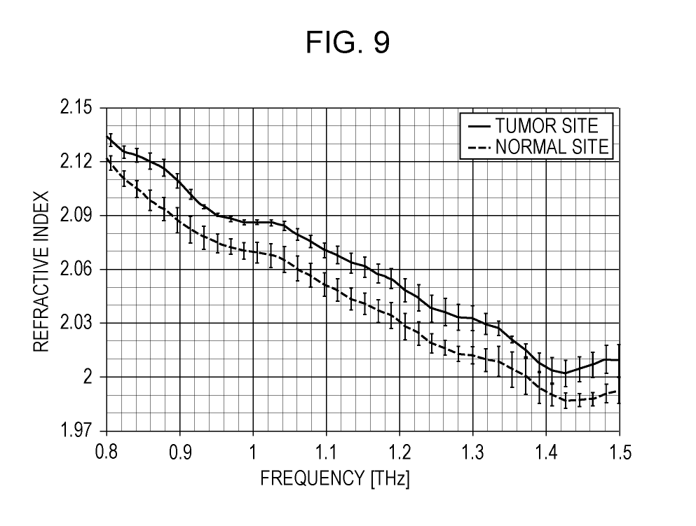

The refractive index spectrum is obtained as the information of the sample 110 by using the temporal waveform obtained after the inclination of the z-cut crystal plate and the sample 110 is previously adjusted in this manner. FIG. 9 illustrates a refractive index spectrum obtained in a tumor site in the sample 110 and a refractive index spectrum obtained in a normal site. The measurement of the temporal waveform is performed by irradiating five mutually different parts of the tumor site and the normal site each with the incident wave 120. The refractive index spectra illustrated in FIG. 9 are average values and standard deviations of the refractive index spectra in the five mutually different parts of the tumor site and the normal site each.

It can be observed that, in the obtained refractive index spectrum, a frequency band is in a range higher than or equal to approximately 0.8 THz and lower than or equal to 1.3 THz, and a refractive index difference higher than or equal to approximately 0.02 and lower than or equal to 0.04 exists between the tumor site and the normal site. It is understood that the refractive index of the tumor site is higher than the refractive index of the normal site. A factor of the existence of the refractive index difference is that a tumor part and a normal part have different cell states and different water volumes. The tumor site has a higher cell density and a larger cell nucleus than the normal site. In addition, the tumor site is in a state in which the water volume is high because of vascularization. It is conceivable that these differences of the cell states and the water volumes appear as the difference of the refractive index spectra.

According to the present example, the incident angle can be adjusted at a satisfactory accuracy by, using the detection result of the terahertz wave that has been reflected by the sample 110. In addition, by performing the inclination adjustment of the sample 110 in advance, it is possible to perform the high accuracy measurement. As a result, according to the present example, the extremely small refractive index difference can be distinguished where the minimum is 0.02.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, according to the above-described embodiment, the sample 110 itself whose information is to be obtained is directly irradiated with the incident wave 120, but the configuration is not limited to this. While a product obtained by contacting a material whose information is to be obtained with a plate-like object which satisfactorily transmits the incident wave 120 is used as the sample 110, the material may be irradiated with the incident wave 120 through the plate-like object. With regard to the plate-like object, a plane on which the incident wave 120 is incident and a plane contacted by the sample 110 face to each other, and the two planes are substantially parallel to each other. At this time, as the information of the sample 110, it is possible to obtain the information of the material surface, the interface in the material, or the like after deduction of the influence from the propagation through the plate-like object by the incident wave 120.

In a case where not so high measurement accuracy is required, a method of performing the adjustment by using the data representing the correlation between the peak value and the full-width at half-maximum of the reflected wave 121 on the temporal waveform and the inclination direction and the inclination amount, may also be used in combination. In addition, according to the above-described embodiment, the peak time difference of the temporal waveform is used for the adjustment of the position in the height direction of the sample 110, but the configuration is not limited to this. A method of obtaining information related to the position in the height direction by using the spectrum and performing the adjustment may also be employed.

In addition, according to the above-described embodiment, the position in the height direction of the sample 110 and the incident angle of the incident wave 120 are adjusted by performing the translational movement and the rotation of the sample 110 supported by the support unit 109. The configuration is not limited to this. A configuration may be adopted in which the position of the sample 110 and the inclination are fixed, and the generation unit 102, the detection unit 103, the irradiation unit 113, the optical system of the reflected wave 121, the optical system of the laser, and the like are collectively moved to adjust the position in the height direction of the sample 110 and the incident angle of the incident wave 120. Furthermore, a combination of these may also be used.

Embodiments of the present invention can also be realized by, a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment (s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like

This application claims the benefit of Japanese Patent Application No. 2013-245901, filed Nov. 28, 2013 and No. 2014-214672, filed Oct. 21, 2014, which are hereby incorporated by reference herein in their entirety.

1. An information obtaining apparatus that obtains information of a sample, the information obtaining apparatus comprising:
an irradiation unit configured to irradiate the sample with a terahertz wave;
a detection unit configured to detect the terahertz wave reflected by the sample;
a spectrum obtaining unit configured to obtain a spectrum from a temporal waveform obtained by using a detection result of the detection unit;
an angle information obtaining unit configured to obtain information related to an incident angle of the terahertz wave from the irradiation unit with respect to the sample by using the spectrum; and
a control unit configured to adjust the incident angle by referring to the information related to the incident angle.

2. The information obtaining apparatus according to claim 1, further comprising:
a sample information obtaining unit configured to obtain the information of the sample from the temporal waveform obtained by using the detection result of the detection unit,
wherein the sample information obtaining unit obtains the information of the sample from the temporal waveform obtained by using the detection result detected by the detection unit in a state in which the incident angle is adjusted.

3. The information obtaining apparatus according to claim 1,
wherein the angle information obtaining unit obtains an adjustment amount of the incident angle by referring to data representing a relationship between the incident angle and the spectrum and the information related to the incident angle, and
wherein the control unit adjusts the incident angle by referring to the adjustment amount.

4. The information obtaining apparatus according to claim 1, wherein the control unit adjusts the incident angle in a manner that the incident angle is fixed irrespective of an irradiation position of the terahertz wave.

5. The information obtaining apparatus according o claim 1,
wherein the angle information obtaining unit obtains first information related to the incident angle from the temporal waveform obtained by using the detection result detected by the detection unit in a state in which the incident angle is a first incident angle and second information related to the incident angle from the temporal waveform obtained by using the detection result detected by the detection unit in a state in which the incident angle is a second incident angle that is different from the first incident angle, and
wherein the control unit adjusts the incident angle by referring to the first and second information.

6. The information obtaining apparatus according to claim 1, wherein the information related to the incident angle includes a ratio between a value of the spectrum at a first frequency and a value of the spectrum at a second frequency.

7. The information obtaining apparatus according to claim 6, wherein the first frequency is a frequency lower than or equal to a center frequency of the spectrum, and the second frequency is a frequency higher than the center frequency.

8. The information obtaining apparatus according to claim 1, wherein the information related to the incident angle includes an inclination of a straight line connecting a point at a first frequency and a point at a second frequency on the spectrum to each other.

9. The information obtaining apparatus according to claim 8, wherein the first frequency is a frequency lower than or equal to a center frequency of the spectrum, and the second frequency is a frequency higher than the center frequency.

10. The information obtaining apparatus according to claim 1, wherein the spectrum obtained by the spectrum obtaining unit includes an amplitude spectrum.

11. The information obtaining apparatus according to claim 10, wherein the angle information obtaining unit obtains the information related to the incident angle by referring to data representing a relationship between the incident angle and the amplitude spectrum and an attenuation of a value of an amplitude at a frequency higher than a center frequency of the amplitude spectrum

12. The information obtaining apparatus according to claim 1, further comprising:
a supporting unit configured to support the sample,
wherein the control unit adjusts the incident angle by moving the supporting unit or moving the irradiation unit and the detection unit.

13. The information obtaining apparatus according to claim 12,
wherein the supporting unit includes a stage that supports and moves the sample, and
wherein the control unit adjusts the incident angle by moving the stage.

14. The information obtaining apparatus according to claim 1,
wherein the angle information obtaining unit obtains information related to a position in a height direction of the sample, and
wherein the control unit adjusts a relative position between a converging position of the terahertz wave and the sample on the basis of the information related to the portion.

15. The information obtaining apparatus according to claim 1, wherein the detection unit includes a first mode in which a detection result used for obtaining the information related to the incident angle is obtained and a second mode in which a detection result used for obtaining the information of the sample is obtained, and the number of detection results obtained in the second mode is higher than the number of detection results obtained in the first mode.

16. An information obtaining method of obtaining information of a sample, the information obtaining method comprising:
irradiating the sample with a terahertz wave;
detecting the terahertz wave reflected by the sample;
obtaining a spectrum from a temporal waveform obtained by using a detection result of the detecting;
obtaining information related to an incident angle of the terahertz wave with respect to the sample by using the spectrum; and
adjusting the incident angle by referring to the information related to the incident angle.

17. The information obtaining method according to claim 16, further comprising:
obtaining the information of the sample from the temporal waveform obtained by using the detection result detected in a state in which the incident angle is adjusted.

18. A computer-readable recording medium recording a program for causing a computer to execute the respective steps of the information obtaining method according to claim 16.
